(19) United States
(12) Patent Application Publication
(10) Pub. No.: US 2018/0223110 A1
(43) Pub. Date: Aug. 9, 2018

(54) MALTODEXTRIN-BASED PAINT BOOTH PROTECTIVE COATINGS

(71) Applicant: Cal-West Specialty Coatings, Inc., Sunnyvale, CA (US)

(72) Inventor: Robert Louis Mesa, Santa Clara, CA (US)

(21) Appl. No.: 15/750,141

(22) PCT Filed: Aug. 4, 2016
(86) PCT No.: PCT/US2016/045614

§ 371 Date: Feb. 2, 2018

Related U.S. Application Data
(60) Provisional application No. 62/201,432, filed on Aug. 5, 2015.

(51) Int. Cl. C09D 5/00; B05B 16/40; C09D 103/02; C09D 5/14; C09D 7/65; C09D 7/63; C09D 7/61; C09D 7/43; C09D 5/02

(52) U.S. Cl. CPC C09D 5/008; B05B 16/40; C09D 103/02; C09D 5/14; C09D 5/021; C09D 7/63; C09D 7/61; C09D 7/43; C09D 7/65

(57) ABSTRACT

In various embodiments novel coatings for the protection of a paint booth are provided. In certain embodiments the coatings comprise a maltodextrin, a humectant; and pH adjuster. In certain embodiments the coatings can optionally additionally comprise a thickener, and/or a defoamer, and/or a surfactant and/or one or more preservatives. In certain embodiments the coating is a clear coating comprising a maltodextrin, a thickener (e.g., an xanthan gum thickener), a defoamer (e.g., a silicone defoamer), a surfactant (e.g., a nonionic surfactant such as an ethoxylated alcohol surfactant), a humectant (e.g., glycerine), a pH adjuster/humectant (e.g., triethanolamine), and one or more preservatives (e.g., of a combination of as 5-chloro-2-methyl-4-isothiazolin-3-one and 2-methyl-4-isothiazolin-4-one (KATHON LX®), an aqueous dipropylene glycol solution of 1,2-benzisothiazolin-3-one (PROXEL GXL®), potassium metabisulfite, etc.).

### CROSS-REFERENCE TO RELATED APPLICATIONS

This application claims benefit of and priority to U.S. Ser. No. 62/201,432, filed on Aug. 5, 2015, which is incorporated herein by reference in its entirety for all purposes.

### STATEMENT OF GOVERNMENTAL SUPPORT

[Not Applicable]

### BACKGROUND

In many industrial applications and/or collision repair shops, painting (or other overcoating) operations are carried out in facilities often referred to as paint booths or spray booths. A paint booth is a partially or fully enclosed structure typically capable of being heated to high temperatures, and it typically contains interior surfaces made of coated metal or other heat resistant materials. Painting operations are conducted in paint booths in order to contain paint overspray produced during the painting operation as well as to provide a controlled environment for curing paint finishes. During painting operations, paint booth surfaces are often contaminated with paint overspray, making the interior surfaces of the paint booth difficult and time consuming to clean.

The presence of airborne dust and the accumulation of dried paint particles known as “paint dust” can cause defects in freshly painted surfaces by being dislodged from the walls of the paint booth and depositing onto freshly painted surfaces or by being stirred up into the air from which they deposit onto the freshly painted surfaces. After heat curing of the paint finish, the embedded paint dust particles must be removed mechanically by sanding and finishing, adding cost and time to the painting process.

The accumulation of paint overspray on paint booth interior surfaces also diminishes the quality and intensity of ambient light available to the painter. The lack of bright, white interior surfaces causes difficulties for the painter in accurately discerning and matching discerning paint colors, potentially leading to painting mistakes which require costly rework.

Over time, paint overspray builds up on the walls, floor gratings and other structures of the booth. Likewise, paint overspray accumulates on conveyors, racks and other equipment which transports articles through a paint spray facility. It is necessary to periodically remove built up paint overspray. Cleaning the unprotected walls of a paint booth can require some level of restoration and refinishing of the walls, often taking a day or more to accomplish, and resulting in significant booth downtime.

Various materials have been employed in an attempt to protect paint booth surfaces. A disadvantage of these materials is that they have generally been difficult and time consuming to apply. These have typically not provided sufficient paint overspray and paint dust capture while adequately enduring the harsh baking environment of the paint booth. Paint booth surface coatings and coverings must endure repeated bake cycles at temperatures up to and in excess of 180° F., yet still be readily removable and replaceable.

Adhesive coated plastic sheets have been employed to cover paint booth surfaces. These plastic sheets are difficult to install and the installation results in many wrinkles which tend to collect and hold paint overspray and other contaminants that in turn are easily dislodged during painting. These dislodged particulates can cause paint dust and lead to defects in the paint coating. In addition, the adhesive bond of the plastic sheets to the booth surfaces builds with time and through repeated bake cycles, making the construction difficult or impossible to remove cleanly without slivering of the film or without adhesive residue. Such materials are also prone to puncture, tear, and wrinkling in more demanding environments.

Other masking materials have similarly suffered. For example, masking papers have been employed, and while stiff and somewhat easier to handle than plastic sheets, they lack flexibility and extensibility to easily fit over or around protrusions or obstacles. Paper is also subject to tearing which produces small fibers that can contribute to contamination.

Sprayable polymeric coatings are another material that has been employed to cover paint booth surfaces. However, under repeated baking cycles the solubility of these coatings decrease, complicating the removal process.

### SUMMARY

In various embodiments paint booth protective compositions are provided. The compositions are typically aqueous, low VOC, formulations that can readily be applied to a paint booth surface (e.g., a wall) by spraying, paint brushing, roller application and the like. The coatings dry to provide an effective protection of the underlying paint booth surface from paint spray. The coatings additionally tolerate repeated cycles of baking and cooling with little degradation and are easily removed from the paint booth walls when desired (e.g., by washing with a water wash).

Various embodiments contemplated herein may include, but need not be limited to, one or more of the following:

### Embodiment 1

A coating for the protection of a paint booth, said coating including an aqueous mixture of: a maltodextrin; a humectant; and a pH adjuster.

### Embodiment 2

The composition of embodiment 1, wherein said maltodextrin has a DE between about 10, or about 11, or about 12, or about 13, or about 14 up to about 20, or from about, or from about 15 up to about 20 or 19.9, or from about 16 up to about 20 or about 19.9.

### Embodiment 3

The composition of embodiment 2, wherein the maltodextrin has a DE that ranges from about 16.5 to about 19.9.

### Embodiment 4

The composition according to any one of embodiments 1-3, where the maltodextrin ranges from about 1%, or from about 3%, or from about 5%, or from about 8%, or from about 10% up to about 40%, or up to about 35%, or up to about 30%, or up to about 25%, or up to about 21%, or ranges from about 10% to about 21% of the composition or is about 10%, or about 21% of the composition.

### Embodiment 5

The composition according to any one of embodiments 1-4, wherein said composition further includes a thickener.

### Embodiment 6

The composition of embodiment 5, wherein said thickener includes an acrylic thickener or an xanthan gum.

### Embodiment 7

The composition of embodiment 5, wherein said thickener includes a xanthan gum.

### Embodiment 8

The composition according to any one of embodiments 5-7, wherein said thickener includes about 0.1 to 3 percent, or about 0.2 percent to about 1 percent, or about 0.3 percent up to about 0.5% of the compositions. In certain embodiments the thickener is present at about 0.475% or at about 0.5%, by weight, of the composition.

### Embodiment 9

The composition according to any one of embodiments 1-8, wherein said composition includes a defoamer.

### Embodiment 10

The composition of embodiment 9, wherein said defoamer includes a VOC-free defoamer.

### Embodiment 11

The composition of embodiment 10, wherein said defoamer includes a silicone defoamer.

### Embodiment 12

The composition of embodiment 10, wherein said defoamer includes a mixture of foam destroying polysiloxanes and hydrophobic solids in polyglycols.

### Embodiment 13

The composition according to any one of embodiments 9-12, wherein said defoamer ranges from about 0.1%, or from about 0.3%, or from about 0.5% up to about 2%, or up to about 1.5%, or up to about 1%, or from about 0.8% up to about 1.2%, or is about 1% by weight of said composition.

### Embodiment 14

The composition according to any one of embodiments 1-12, wherein said composition further includes a surfactant.

### Embodiment 15

The composition of embodiment 14, wherein said surfactant includes a non-ionic surfactant.

### Embodiment 16

The composition of embodiment 14, wherein said surfactant includes a siloxane and/or an ethoxylated alcohol.

### Embodiment 17

The composition of embodiment 14, wherein said surfactant includes an ethoxylated alcohol.

### Embodiment 18

The composition according to any one of embodiments 14-17. wherein said surfactant ranges from about 0.05%, or from about 0.1% up to about 0.5% of the composition, or up to about 0.4%, or up to about 0.3%, or up to about 0.2% by weight of the composition.

### Embodiment 19

The composition according to any one of embodiments 1-18, wherein said pH adjuster is a water soluble base.

### Embodiment 20

The composition of embodiment 19, wherein said pH adjuster is selected from the group consisting of sodium hydroxide, sodium bicarbonate, pyridine, triethanolamine, and ammonia.

### Embodiment 21

The composition according to any one of embodiments 1-20, wherein said pH adjuster adjusts pH of said composition to between pH 7 and pH 9, or to between about pH 8 to about pH 9.

### Embodiment 22

The composition according to any one of embodiments 1-21, wherein said pH adjuster is also a humectant.

### Embodiment 23

The composition of embodiment 22, wherein pH adjuster includes triethanolamine.

### Embodiment 24

The composition according to any one of embodiments 1-23, wherein the pH adjuster ranges from about 0.1% up to about 30%, or from about 0.5% up to about 30%, or up to about 20%, or up to about 15%, or up to about 10%, or up to about 1%, or up to about 2%, or up to about 1%, or is about 0.5%, or is about 0.9% of the composition.

### Embodiment 25

The composition according to any one of embodiments 1-24, wherein said humectant is selected from the group consisting of glycerine, sorbitol, sugar, corn syrup, and polypropylene glycol.

### Embodiment 26

The composition of embodiment 25, wherein said humectant includes glycerin.

### Embodiment 27

The composition according to any one of embodiments 1-26, wherein said humectant ranges from about 2%, 3%, 4%, or 5% of the composition up to about 50%, or up to about 40%, or up to about 30% of the composition, or up to about 20% of the composition, or is about 4 to about 8% or the composition, or is about 12% to about 18% of the composition, or is about 5% of the composition, or is about 15% of the composition.

### Embodiment 28

The composition according to any one of embodiments 1-27, wherein said composition further includes one or more preservatives.

### Embodiment 29

The composition of embodiment 28, wherein said preservatives includes one or more agents selected from the group consisting of a combination of as 5-chloro-2-methyl-4-isothiazolin-3-one and 2-methyl-4-isothiazolin-4-one (KATHON LX®), an aqueous dipropylene glycol solution of 1,2-benzisothiazolin-3-one (PROXEL GXL®), benzoic acid, sodium benzoate, hydroxybenzoate and derivatives, lactic acid, nitrate, nitrite, propionic acid, sodium propionate, sulfur, sulfites, sorbic acid sodium sorbate, thimerosol, and potassium metabisulfite.

### Embodiment 30

The composition of embodiment 28, wherein said preservatives includes one or more agents selected from the group consisting of a combination of as 5-chloro-2-methyl-4-isothiazolin-3-one and 2-methyl-4-isothiazolin-4-one (KATHON LX®), an aqueous dipropylene glycol solution of 1,2-benzisothiazolin-3-one (PROXEL GXL®), and potassium metabisulfite.

### Embodiment 31

The composition according to any one of embodiments 28-30, where each preservative, when present ranges up to about 4%, or up to about 3%, or up to about 2%, or up to about 1% of the composition, or 0.005% up to about to about 1%, or about 0.10% up to about 0.2%, or up to about 0.01%, or up to about 1%, or is about 0.010%, or about 0.95%, or about 0.2% of said composition.

### Embodiment 32

The composition according to any one of embodiments 28-31, wherein said composition includes up to about 0.10 Kathon LX, or about 0.01% Kathon LX.

### Embodiment 33

The composition according to any one of embodiments 28-32, wherein said composition includes up to about 4% Proxel GXL, or about 0.2% Proxel GXL.

### Embodiment 34

The composition according to any one of embodiments 28-33, wherein said composition includes up to about 1% potassium metabisulfite or about 0.95% potassium metabisulfite, or about 0.5% potassium metabisulfite.

### Embodiment 35

The composition according to any one of embodiments 1-34, wherein said composition further includes a pigment.

### Embodiment 36

The composition of embodiment 35, wherein said pigment is a white pigment.

### Embodiment 37

The composition of embodiment 36, wherein said pigment includes titanium dioxide.

### Embodiment 38

The composition according to any one of embodiments 35-37, wherein said pigment ranges up to about 12% of said composition or up to about 10% of said composition, or up to about 8% of said composition, or up to about 6% of said composition, or up to about 5% of said composition, or up to about 4% of said composition, or up to about 3% of said composition, or up to about 2% of said composition, or up to about 1% of said composition or includes about 6% of the composition.

### Embodiment 39

The composition of embodiment 1, wherein said composition includes: up to about 25% maltodextrin; up to about 5% thickener; up to about 2% defoamer; up to about 0.5% surfactant; up to about 30% glycerine; up to about 30% triethanolamine; and one or more preservatives.

### Embodiment 40

The composition of embodiment 39, wherein said composition includes: about 21% maltodextrin; about 5% or about 0.475% xanthan gum thickener (e.g. kelzan® ar); about 0.1% silicone defoamer (e.g., byk-024); about 0.2% alcohol ethoxylated surfactant (e.g. tomadol 91.6); about 15% glycerine; about 0.9% triethanolamine; and one or more preservatives.

### Embodiment 41

The composition of embodiment 40, wherein said composition further includes about 6% titanium dioxide.

### Embodiment 42

The composition of embodiment 39, wherein said composition includes: about 10% maltodextrin; about 5% or about 0.475% xanthan gum thickener (e.g. kelzan® ar); about 0.1% silicone defoamer (e.g., byk-024); about 0.2% alcohol ethoxylated surfactant (e.g. tomadol 91.6); about 5% glycerine; about 0.5% triethanolamine and one or more preservatives.

### Embodiment 43

The composition according to any one of embodiments 39-42, wherein said composition further includes about 0.2% Proxel GXL.

### Embodiment 44

The composition according to any one of embodiments 39-43, wherein said composition further includes about 0.2% Proxel GXL.

### Embodiment 45

The composition according to any one of embodiments 39-44, wherein said composition further includes about 0.01% Kathon LX.

### Embodiment 46

The composition according to any one of embodiments 39-45, wherein said composition further includes about 9.14 potassium metabisulfite.

### Embodiment 47

The composition according to any one of embodiments 39-46, wherein the remainder of said composition is distilled or deionized water.

### Embodiment 48

The composition according to any one of embodiments 1-47, wherein said composition remains damp and/or tacky/sticky to the touch after drying.

### Embodiment 49

The composition according to any one of embodiments 1-48, wherein said composition is formulated for aerosol application.

### Embodiment 50

The composition of embodiment 49, wherein said composition is in a paint sprayer.

### Embodiment 51

The composition of embodiment 49, wherein said composition is in a pressurized aerosol spray can.

### Embodiment 52

A method of protecting a surface of a paint booth, said method including applying the composition according to any one of embodiments 1-51 to a surface of a paint booth in an amount to form a substantially continuous coating.

### Embodiment 53

The method of embodiment 52, wherein said coating is applied in an amount sufficient to prevent penetration of paint to the underlying surface.

### Embodiment 54

The method according to any one of embodiments 52-53, wherein said applying is by brush, roller, or spraying.

### Embodiment 55

The method according to any one of embodiments 52-54, wherein said method includes refreshing said paint booth surface by applying said composition again to a previous layer of composition that has been marred by a painting operation (e.g., marred by paint, paint fragments, dust, and the like).

### Embodiment 56

The method according to any one of embodiments 52-55, wherein said method includes removing said composition from the surface of said paint booth after one or more painting operations.

### Embodiment 57

The method of embodiment 56, wherein said removing is by a water wash.

### BRIEF DESCRIPTION OF THE DRAWINGS

[Not Applicable]

### DETAILED DESCRIPTION

In various embodiments paint booth protective compositions are provided. The compositions are typically aqueous, low VOC, formulations that can readily be applied to a paint booth surface (e.g., a wall) by spraying, paint brushing, roller application and the like. The coatings dry to provide an effective protection of the underlying paint booth surface from paint spray. The coatings additionally tolerate repeated cycles of baking and cooling with little degradation and are easily removed from the paint booth walls when desired (e.g., by washing with a water wash).

Additionally, the booth coatings described herein remain tacky (e.g., retaining a slightly sticky feel; not fully dry, etc.) after application/drying. The tackiness of the coatings facilitates entrapment/capture and/or reduction of airborne dust and the accumulation of dried paint particles. The tacky coatings can also help prevent paint particles (e.g., paint dust) from being dislodged from the paint booth wall.

In various embodiments the coatings comprise a maltodextrin, a humectant; and pH adjuster. In certain embodiments the coatings can optionally additionally comprise a thickener, and/or a defoamer, and/or a surfactant and/or one or more preservatives. In certain embodiments the coating is a clear coating comprising a maltodextrin, a thickener (e.g., an xanthan gum thickener), a defoamer (e.g., a silicone defoamer), a surfactant (e.g., a nonionic surfactant such as an ethoxylated alcohol surfactant), a humectant (e.g., glycerine), a pH adjuster/humectant (e.g., triethanolamine), and one or more preservatives (e.g., of a combination of as 5-chloro-2-methyl-4-isothiazolin-3-one and 2-methyl-4-isothiazolin-4-one (KATHON LX®), an aqueous dipropylene glycol solution of 1,2-benzisothiazolin-3-one (PROXEL GXL®), potassium metabisulfite, etc.).

Table 1 shows an illustrative, but non-limiting embodiment of a tacky clear booth coating composition.

TABLE 1
Illustrative formulation of clear tacky booth coating. The substitutions shown are
illustrative and not limiting. Percentages are weight percent.

| | Illustrative | | Range | Range | Illustrative |
|---|---|---|---|---|---|
| Component | Ingredient | Preferred | Low | High | Substitutions |
| Thickener | CP Kelco, Kelzan | 0.475% | 0% | 5% | Carboxymethylcellulose |
| | AR | | | | Hydroxymethylcellulose |
| Resin | Grain Processing | 21% | 1% | 50% | |
| | Corporation, | | | | |
| | Maltrin M180 | | | | |
| Defoamer | BYK Chemie, | 0.1% | 0% | 2% | BYK 023,026,027 |
| | BYK 024 | | | | |
| Surfactant | Shell, Tomadol | 0.2% | 0% | 2% | |
| | 91.6 | | | | |
| Humectant | Glycerine, | 15% | 0.25% | 30% | Sorbitol, sugar, corn |
| | Technical Grade | | | | syrup, other plant syrups |
| Humectant/ | TEA, | 0.9% | 0.5% | 30% | |
| pH | Triethanolamine | | | | |
| Adjustment | | | | | |
| Preservative | Arch Chemical, | 0.2% | 0% | 4% | |
| | Proxel GXL | | | | |
| Preservative | Rohm and Haas, | 0.01% | 0% | 0.1% | |
| | Kathon LX 14 | | | | |
| Preservative | Potassium | 0.95% | 0% | 1% | |
| | Metabisulfite | | | | |
| | (granular) | | | | |
| | DI Water | 61.165% | | | |
| Total | | 100% | | | |

Table 2 shows an illustrative, but non-limiting embodiment of a tacky opaque booth coating composition, in this case white due to the titanium dioxide pigment.

TABLE 2
Illustrative formulation of an opaque (white) tacky booth coating. The
substitutions shown are illustrative and not limiting. Percentages are weight percent.

| | Illustrative | | Range | Range | Illustrative |
|---|---|---|---|---|---|
| Component | Ingredient | Preferred | Low | High | Substitutions |
| Thickener | CP Kelco, Kelzan | 0.475% | 0% | 5% | Carboxymethylcelluose |
| | AR | | | | Hydroxymethylcellulose |
| Resin | Grain Processing | 21% | 1% | 50% | |
| | Corporation, | | | | |
| | Maltrin M180 | | | | |
| Defoamer | BYK Chemie, | 0.1% | 0% | 2% | BYK 023,026,027 |
| | BYK 024 | | | | |
| Pigment | Tronox, Titanium | 6% | 1% | 21% | |
| | Dioxide Powder, | | | | |
| | CR 828 | | | | |
| Surfactant | Air Products, | 0.2% | 0% | 2% | |
| | Tomadol 91.6 | | | | |
| Humectant | Glycerine, | 15% | 0.25% | 30% | Sorbitol, sugar, corn |
| | Technical Grade | | | | syup, other plant syrups |
| Humectant/ | TEA, | 0.9% | 0.50% | 30% | |
| pH | Triethanolamine | | | | |
| Adjustment | | | | | |
| Preservative | Arch Chemical, | 0.2% | 0% | 4% | |
| | Proxel GXL | | | | |
| Preservative | Rohm and Haas, | 0.01% | 0% | 0.1% | |
| | Kathon LX 14 | | | | |
| Preservative | Potassium | 0.950% | 0% | 1% | |
| | Metabisulfite | | | | |
| | (granular) | | | | |
| | DI Water | 61.165% | | | |
| Total | | 100% | | | |

Table 3 shows an illustrative formulation of a booth coating composition formulated for use as an aerosol. The substitutions shown are illustrative and not limiting. The formulation is for a clear aerosol, but it will be recognized that a pigment (e.g., titanium dioxide) can be added to provide an opaque aerosol coating composition.

TABLE 3
Illustrative formulation of a clear aerosol booth coating. The substitutions shown
are illustrative and not limiting. Percentages are weight percent.

| | Illustrative | | Range | Range | Illustrative |
|---|---|---|---|---|---|
| Component | Ingredient | Preferred | Low | High | Substitutions |
| Thickener | CP Kelco, Kelzan | 0.475% | 0% | 1% | Carboxymethylcellulose |
| | AR | | | | Hydroxymethylcellulose |
| Resin | Grain Processing | 10% | 1% | 30% | |
| | Corporation, | | | | |
| | Maltrin M180 | | | | |
| Defoamer | BYK Chemie, | 0.1% | 0% | 1% | BYK 023,026,027 |
| | BYK 024 | | | | |
| Surfactant | Air Products, | 0.2% | 0% | 0.5% | |
| | Tomadol 91.6 | | | | |
| Humectants | Glycerine, | 5% | 0.25% | 30% | Sorbitol, sugar, corn |
| | Technical Grade | | | | syrup, other plant syrups |
| Humectant/ | TEA, | 0.5% | 0.5% | 30% | |
| pH | Triethanolamine | | | | |
| Adjustment | | | | | |
| Preservative | Arch Chemical, | 0.2% | 0% | 4% | |
| | Proxel GXL | | | | |
| Preservative | Rohm and Haas, | 0.01% | 0% | 0.1% | |
| | Kathon LX 14 | | | | |
| Preservative | Potassium | 0.95% | 0% | 1% | |
| | Metabisulfite | | | | |
| | (granular) | | | | |
| Water | DI Water | 82.57% | | | |
| (remainder) | | | | | |
| Total: | | 100% | | | |

In various embodiments paint booth protection compositions are contemplated that are “dry” (e.g., not tacky). Illustrative formulations for a dry clear paint booth coating are shown in Table 4, while illustrative formulations for a tinted (in this case white) paint booth coating are shown in Table 5.

TABLE 4
Illustrative, but non limiting formulations for a dry (non-tacky) clear paint booth
coating.

| | Illustrative | | Range | Range | Illustrative |
|---|---|---|---|---|---|
| Component | Ingredient | Preferred | Low | High | Subsitutions |
| Thickener | CP Kelco, Kelzan | 0.475% | 0.00% | 5.00% | |
| | AR | | | | |
| Resin | Grain Processing | 20.000% | 1.00% | 50.00% | Carboxymethylcellulose |
| | Corporation, | | | | Hydroxymethylcellulose |
| | Maltrin M180 | | | | |
| Resin | Grain Prossesing | 2.000% | 0% | 10.00% | Pure-Coat B790 |
| | Corp, INSTANT | | | | |
| | PURE-COTE | | | | |
| | B792 | | | | |
| Defoamer | BYK Chemie, | 0.100% | 0.00% | 2.00% | BYK 023,026,027 |
| | BYK 024 | | | | |
| Surfactant | Air Products, | 0.200% | 0.00% | 2.00% | |
| | Tomadol 91.6 | | | | |
| Humectant | Glycerine, | 1.000% | 0.00% | 10.00% | Sorbitol, sugar, corn syup |
| | Technical Grade | | | | |
| Humectant/pH | TEA, | 0.900% | 0.00% | 10.00% | |
| Adjustment | Triethanolamine | | | | |
| Preservative | Arch Chemical, | 0.200% | 0.00% | 4.00% | |
| | Proxel GXL | | | | |
| Preservative | Rohm and Haas, | 0.010% | 0.00% | 0.10% | |
| | Kathon LX 14 | | | | |
| Preservative | Potassium | 0.950% | 0.00% | 1.00% | |
| | Metabisulfite | | | | |
| | (granular) | | | | |
| | DI Water | 74.165% | | | |
| Total: | | 100% | | | |

TABLE 5
Illustrative, but non limiting formulations for a dry (non-tacky) tinted (white) paint
booth coating.

| | | | Range | Range | |
|---|---|---|---|---|---|
| Component | Ingredient | Preferred | Low | High | Options |
| Thickener | CP Kelco, Kelzan | 0.475% | 0.00% | 5.00% | |
| | AR | | | | |
| Resin | Grain Processing | 20.000% | 1.00% | 50.00% | Carboxymethylcellulose |
| | Corporation, | | | | Hydroxymethylcellulose |
| | Maltrin M180 | | | | |
| Resin | Grain Prossesing | 2.000% | 0% | 10.00% | Pure-Coat B790 |
| | Corp, INSTANT | | | | |
| | PURE-COTE | | | | |
| | B792 | | | | |
| Defoamer | BYK Chemie, | 0.100% | 0.00% | 2.00% | BYK 023,026,027 |
| | BYK 024 | | | | |
| Pigment | Tronox, Titanium | 6.000% | 1.00% | 12.00% | |
| | Dioxide Powder, | | | | |
| | CR 828 | | | | |
| Surfactant | Shell, Tomadol | 0.200% | 0.00% | 2.00% | |
| | 91.6 | | | | |
| Humectant | Glycerine, | 1.000% | 0.00% | 10.00% | Sorbitol, sugar, corn syup |
| | Technical Grade | | | | |
| Humectant/pH | TEA, | 0.900% | 0.00% | 10.00% | |
| Adjustment | Triethanolamine | | | | |
| Preservative | Arch Chemical, | 0.200% | 0.00% | 4.00% | |
| | Proxel GXL | | | | |
| Preservative | Rohm and Haas, | 0.010% | 0.00% | 0.10% | |
| | Kathon LX 14 | | | | |
| Preservative | Potassium | 0.950% | 0.00% | 1.00% | |
| | Metabisulfite | | | | |
| | (granular) | | | | |
| | DI Water | 68.165% | | | |
| | Total | 100% | | | |

The compositions are formulated simply by mixing the components as indicated in the tables. It is noted that in certain embodiments, the potassium metabisulfite, when present, is mixed with water separately (until clear) and then added to the mixture of other components, e.g., as shown in the Tables.

While Tables 1-5 illustrate particular embodiments of the protective paint booth compositions, one of skill in the art will recognize that numerous variations on the individual components and ranges of those components in the formulation, can be prepared, e.g., as described below.

### Maltodextrin.

In various embodiments the paint booth protecting composition comprises a maltodextrin. Maltodextrin is a polysaccharide that is often used as a food additive. It is produced from starch by partial hydrolysis and is usually found as a white hygroscopic spray-dried powder. Maltodextrin consists of D-glucose units connected in chains of variable length. The glucose units are primarily linked with α(1→4) glycosidic bonds. Maltodextrin is typically composed of a mixture of chains that vary from three to seventeen glucose units long.

Maltodextrins are classified by DE (dextrose equivalent) and typically have a DE between 3 to 20. The higher the DE value, the shorter the glucose chains, the higher the sweetness, the higher the solubility and the lower heat resistance. Above DE 20, the European Union's CN code calls it glucose syrup.

In certain embodiments the maltodextrin used in the compositions herein has a DE between about 10, or about 11, or about 12, or about 13, or about 14 up to about 20, or from about, or from about 15 up to about 20 or 19.9, or from about 16 up to about 20 or about 19.9. In certain embodiments the maltodextrin has a DE that ranges from about 16.5-19.9 (e.g., Maltrin M180).

In certain embodiments the maltodextrin ranges from about 1%, or from about 3%, or from about 5%, or from about 8%, or from about 10% up to about 40%, or up to about 35%, or up to about 30%, or up to about 25%, or up to about 21%, or ranges from about 10% to about 21% of the composition or is about 10%, or about 21% of the composition by weight.

### Thickeners.

In certain embodiments, the film former(s) can optionally, additionally comprise one or more thickeners. Thickeners, in particular thixotropic (shear-thinning) thickeners, can act as film formers and, when used as such, are capable of preventing penetration of a coating material (e.g. paint) to an underlying surface (e.g. the surface as a vehicle.

Suitable commercial thickeners well known to those of skill in the art include, but are not limited to, Montmorillonite, EZ-1, BFG, Acrysol™ (e.g ACRYSOL® RM 825, ACRYSOL® RM-W8, ACRYSOL® RM-W12, and the like), RHEOLATE® (e.g., RHEOLATE® 450, Rheox Co.), OPTIFLO® (e.g., OPTIFLO® TVS, OPTIFLO® H600, from Sud-Chemie), and the like. Certain desirable thickeners include, but are not limited to various polymer or polymer emulsion thickeners such as silicone based thickeners, acrylic emulsion thickeners (e.g., CARBOPOL® EP1, CARBOPOL®1324, etc.) and acrylic copolymers (e.g., CARBOPOL® EZ-1, CARBOPOL® EZ-3), polyether polyol-based associative thickener (e.g., RHEOLATE® 350), and the like.

In certain embodiments thickener, when present comprises a xanthan gum (e.g. KELZAN® AR) and/or a polyether polyol- based associative thickener (e.g., RHEOLATE® 350).

Acrylic thickeners selected for low water sensitivity (e.g., Carbopol® EP1) are also suitable, as are associative thickeners. Alkali-swellable acrylic emulsion thickeners capable of imparting shear-thinning characteristics (e.g., Carbopol® EP1) may also be used.

Suitable thickeners include, but are not limited to neutralized crosslinked acrylate copolymers, neutralized crosslinked polyacrylic acids, neutralized polyacrylic acids, algins, carboxymethylcellulose, neutralized polymethacrylic acids, neutralized ethylene-acrylic acid copolymers, methocel, gum arabic, cellulose gum, neutralized styrene acrylic acid copolymers, and combinations thereof.

In certain embodiments the thickener can be absent. In various other embodiments, the thickener may be present at about 0.1 to 3 percent, or about 0.2 percent to about 1 percent, or about 0.3 percent up to about 0.5% of the compositions. In certain embodiments the thickener is present at about 0.475% or at about 0.5%, by weight, of the composition.

### Defoamer.

In certain embodiments, the paint booth coating compositions includes one or more defoamers. The defoamer(s) break bubbles, and prevent bubble patterns that would otherwise appear in the coating. In addition defoamers facilitate the loading of pressurized aerosol spray cans, pump sprayers or any other container in which the coating composition is to be stored and/or transported. Foam reduction allows more complete filling of the receptacle with the coating composition and reduces time spent waiting for foam to diminish during loading operations.

Desirable defoamers are compatible with aqueous systems and typically include a primary antifoam agent such as a hydrophobic silica, fatty amide, hydrocarbon wax, fatty acid, or fatty ester. Certain defoamers can include, but are not limited to, combined surfactant-defoamers. Various defoamers include, but are not limited to FOAMASTER®, BUBBLE BREAKER®, and 1 and 2 octanol.

In various preferred embodiments the defoamer is a silicone-based defoamer (e.g., BYK-023, BYK®-024, BYK-027, and the like from BYK Chemie GmbH (West Germany)). It is noted that BYK-024 is a BYK-024 is a mixture of foam destroying polysiloxanes and hydrophobic solids in polyglycols

In certain embodiments the defoamer, when present, ranges from about 0.1%, or from about 0.3%, or from about 0.5% up to about 2%, or up to about 1.5%, or up to about 1%, or from about 0.8% up to about 1.2%, or is about 1% by weight of the composition.

### pH Adjustment

In various embodiments the paint booth protecting compositions comprise a component to adjust pH of the composition. Means of adjusting pH are well known to those of skill in the art. In certain embodiments it is often desirable to adjust the composition to a basic pH of about 8 to about 9. This may be accomplished by the addition of one of a number of water soluble bases well known to those of skill in the art. These include, but are not limited to sodium hydroxide, sodium bicarbonate and amine bases such as pyridine and ethylamine and ammonia. In one particularly preferred embodiment, the pH of the coating composition is adjusted to a slightly basic pH (e.g. pH^{˜}8.0). This tends to prevent agglomeration of the maltodextrin, particularly during storage.

In certain embodiments the pH adjuster can also function as a humectant. Thus, for example, triethanolamine can function as a dual purpose agent, a pH adjuster and a humectant.

In certain embodiments the pH adjuster (e.g., triethanolamine) ranges from about 0.1% up to about 30%, or from about 0.5% up to about 30%, or up to about 20%, or up to about 15%, or up to about 10%, or up to about 1%, or up to about 2%, or up to about 1%, or is about 0.5%, or is about 0.9% of the composition.

### Surfactant.

To provide a continuous and level film, the paint booth protecting composition preferably adequately wets the surface to be protected. In various embodiments the paint booth protecting compositions can comprise one or more surfactants to facilitate such wetting.

Suitable surfactants include ionic surfactants (cationic or anionic), nonionic surfactants, amphoteric surfactants, and the like.

Examples of nonionic surfactants include various ethoxylated alcohols (alcohol ethoxylates). Such ethoxylated alcohols, include but are not limited to monoethers of polyethylene glycols and long chain alkanols in which the alkanol has 10 to 16 carbon atoms and the polyethylene glycol has 5 to 15 oxyethylene units. Such monoethers of polyethylene glycol are generally made by reacting the alkanol with ethylene oxide. Such nonionic surfactants are well known to those of skill in the art and are commercially available. For example, commercially available TOMADOL® 25-7, a nonionic surfactant, is an adduct of 7 mols of ethylene oxide and 1 mol of a mixture of alkanols of 12 to 15 carbon atoms. Other related nonionic surfactants include TOMADOL® 25-3, NEODOL® 4511, NEODOL®2503, ALFONIC® 1618-65, PLURAFAC® B26, and the like. in certain embodiments the alcohol ethoxylate comprises RHODASURF® TDA-8.5 available from Rhodia in Cranbury, N.J. (USA).

Ionic surfactants include anionic and cationic surfactants. Suitable anionic surfactants are well known to those of skill in the art and include, but are not limited to various carboxylates, N-acylsarcosinates, acylated protein hydrolysates including various sulfonates, ethoxylated and/or sulfonated alkylphenols, and the like. Cationic surfactants are also well known to those of skill in the art and include, but are not limited to aliphatic mono-, di- and polyamines derived from fatty and rosin acids, quaternary ammonium salts, and the like.

Suitable amphoteric surfactants include, but are not limited to, the alkylbetaines, alkyldimethylamines, amphoteric imidazolinium derivatives, and the like.

Also suitable is TRITON® X-100 (C₁₄H₂₂O(C₂H₄O)ₙ, where the average number of ethylene oxide units per molecule is around 9 or 10) and surfactants having fluorinated alkyl chains such as “FLUORAD®” products sold by Minnesota Mining and Manufacturing (“3M”, St. Paul, Minn., U.S.A.) and “ZONYL®” products sold by The Chemours Company (Wilmington, Del., U.S.A.) are also suitable. In addition, many embodiments can include polyethoxy adducts or modified (poly)ethoxylates such as TRITON® DF-12 and DF-16 sold by Dow Chemical Company (Pittsburg, Calif., U.S.A.). Other surfactants include nonylphenoxypolyethanol (such as IGEPAL CO-660 made by Sigma Aldrich, St. Louis, Mo., USA), polyoxyalkylene glycol (such as MACOL® 18 and 19 made by Mazer Chemicals), acetylenic diol-based surfactants (such as SURFYNOL® 104 made by Air Products), and the like.

In various embodiments the surfactant(s) comprise one or more silicone (siloxane-based) surfactants. Such surfactants include, but are not limited to silicone polyoxyalkylene copolymers, organosilicone-polyether copolymer surfactants, and the like. Such surfactants include, but are not limited to various dimethicone surfactants such as PEG-11 methyl ether dimethicone (e.g., GRANSURF® 71), PEG-10 dimethicone (e.g., GRANSURF® 77), stearoxymethicone/dimethicone copolymer (e.g., GRANSIL® ST-9), and the like. In certain embodiments, preferred siloxane-based surfactants include BYK® surfactants (e.g., BYK-345, BYK346, BYK-347, BYK-348, and the like) available from BYK Chemie GmbH (Germany). Other silicone surfactants can be identified for example in Hill (1999) Silicon Surfactants, Marcel Decker, N.Y.

In certain embodiments, the surfactant comprises a linear fatty alcohol ether sulfate (e.g., CH₃(CH₂)₁₀CH₂(OCH₂CH₂)₃OSO₃NH₄ available as STEOL® CA-460 from Stepan).

In certain embodiments suitable surfactants include, but are not limited to anionic surfactants (e.g., alkyl sulfates (e.g. RHODAPON™), ether sulfates (e.g., RHODAPEX™), sulfonates (e.g. RHODACAL™), dodecylbenzene sulfonates, alpha-olefin sulfonates, diphenyl oxide disulfonates, phosphate esters (e.g. Rhodafac™), carboxylates (e.g. Miranate™), etc.), cationic surfactants (e.g., imidazolines (e.g. Miramine™), ethoxylated amines (e.g. Rhodameen™, etc.), non-ionic surfactants (e.g., nonylphenol ethoxylates (e.g. Igepal CO series), octylphenol ethoxylates (e.g. Igepal CA series), nonionic esthers (e.g. Alkamuls™), oleyl alcohol ethoxylates (e.g. Rhodasurf™) ethoxylated mercaptans (e.g. Alcodet™), capped ethoxylates (e.g. Antarox™), blocked polymers, etc.), and amphoteric surfactants (e.g., imidazoline derivatives (Miranol™), fatty amine derivatives (e.g., Mirataine™), etc.). In certain embodiments, the paint booth protection composition includes nonionic alkyl aryl surfactants such as Triton CF-10 and CF-12 (Rohm & Haas, Philadelphia, Pa., U.S.A.). Also suitable is Triton X-100 and surfactants having fluorinated alkyl chains such as “Fluorad” products sold by Minnesota Mining and Manufacturing (St. Paul, Minn., U.S.A.) and “Zonyl” products sold by DuPont Company (Wilmington, Del., U.S.A.) are also suitable. In addition, many embodiments include polyethoxy adducts or modified (poly)ethoxylates such as Triton DF-12 and DF-16 sold by Union Carbide (Danbury, Conn., U.S.A.). Other surfactants include nonylphenoxypolyethanol (such as IGEPAL CO-660 made by GAF), polyoxyalkylene glycol (such as Macol 18 and 19 made by Mazer Chemicals), acetylenic diol-based surfactants (such as Surfynol 104Amade by Air Products), and the like.

One role the surfactant in the paint booth protection composition is facilitate wetting of the substrate (the underlying surface) by the paint booth protection composition thereby leading to the formation of a continuous film. In certain embodiments, a sufficiently continuous protective film could be obtained with little or no surfactant so long as underlying surface is sufficiently clean and/or the paint booth protection composition contains a very high solids content (e.g., high concentrations of thickener). Films containing high solids concentrations are often highly viscous and therefore difficult to apply, especially by spraying. The use of surfactants or other wetting agents is preferred as coatings containing surfactants show superior film-forming properties in a variety of application methods even where solids content is quite low.

It has been discovered that a in certain embodiments the surfactants include one or more non-ionic surfactants. Certain preferred surfactants include alcohol ethoxylates (e.g. TOMADOL™ 91-6. In certain embodiments the surfactant is TOMADOL™ 91-6 or TRITON™ DF-16. In one embodiment the surfactant is a low foam non-ionic surfactant.

The surfactant is typically present in an amount effective to produce a coating that lays out smoothly in a substantially continuous film on the surface of a paint booth. In various embodiments, when present, the surfactant ranges from about 0.05%, or from about 0.1% up to about 0.5% of the composition, or up to about 0.4%, or up to about 0.3%, or up to about 0.2% by weight of the composition.

### Humectants.

In various embodiments the paint booth protection compositions contain one or more agents that provide wetness and/or stickiness. Suitable agents include, for example, various humectants that provide wetness and/or tackiness to facilitate dust suppression. Suitable humectants include, but are not limited to glycol ethers (e.g., polyethylene glycol, polypropylene glycol, etc.), glycerine, sugar, sorbitol, corn syrup and other plant syrups, and the like. Typically the about 2%, 3%, 4%, or 5% of the composition up to about 50%, or up to about 40%, or up to about 30% of the composition, or up to about 20% of the composition, or is about 4 to about 8% or the composition, or is about 12% to about 18% of the composition, or is about 5% of the composition, or is about 15% of the composition.

### Preservatives.

In certain embodiments the paint booth protection compositions contain one or more preservatives. Illustrative preservatives include, but are not limited to of a combination of as 5-chloro-2-methyl-4-isothiazolin-3-one and 2-methyl-4-isothiazolin-4-one (KATHON LX®), a 20% aqueous dipropylene glycol solution of 1,2-benzisothiazolin-3-one (PROXELGXL®), benzoic acid, sodium benzoate, hydroxybenzoate and derivatives, lactic acid, nitrate, nitrite, propionic acid, sodium propionate, sulfur, sulfites, sorbic acid sodium sorbate, thimerosol, potassium metabisulfite, and the like.

In various embodiments, when present, the preservatives range ranges up to about 4%, or up to about 3%, or up to about 2%, or up to about 1% of the composition, or 0.005% up to about to about 1%, or about 0.10% up to about 0.2%, or up to about 0.01%, or up to about 1%, or is about 0.010%, or about 0.95%, or about 0.2% of the composition.

In certain embodiments the composition comprises up to about 0.10 Kathon

LX, or about 0.01% Kathon LX.

In certain embodiments the composition comprises up to about 4% Proxel GXL, or about 0.2% Proxel GXL.

In certain embodiments the composition comprises up to about 1% potassium metabisulfite or about 0.95% potassium metabisulfite, or about 0.5% potassium metabisulfite.

### Pigments.

In various embodiments the paint booth protection compositions additionally comprise one or more pigments. The pigment is typically a finely divided material that contributes to optical and other properties of the composition. The pigment is typically insoluble in the coating medium (e.g., the aqueous dispersion) and is typically mechanically mixed with the coating and deposited when the coating dries. The physical properties of the pigment are typically not changed by incorporation in and deposition from the coating. Illustrative pigments include, but are not limited to, inorganic “white” pigments although colored and certain organic pigments are also suitable. Suitable inorganic white pigments include, but are not limited to, titanium dioxide, white lead, zinc oxide, lithopone (a mixture of zinc sulfide and barium sulfate), zinc sulfide and antimony oxide. Titanium dioxide (e.g., TI-PURE™ R-902, DuPont Chemicals, Wilmington, Del., USA) is particularly suitable because of its high efficiency (unit opacity/weight). The pigment may be present at about 1% to about 20%, more preferably about 1% or 2% to about 8% or 10% and most preferably about 4% to about 6% (e.g., about 4.5%) by weight, of the composition. In certain embodiments the pigment ranges up to about 12% of said composition or up to about 10% of said composition, or up to about 8% of said composition, or up to about 6% of said composition, or up to about 5% of said composition, or up to about 4% of said composition, or up to about 3% of said composition, or up to about 2% of said composition, or up to about 1% of said composition or comprises about 6% of the composition.

### Uses of the Compositions.

The compositions provided herein provide effective protection of a surface of a paint booth when applied thereto. Such surfaces include, but need not be limited to walls, ceiling, floor, and windows when present.

The coating are applied by any convenient method including brushing, rolling, application by paint sprayer and the like. As noted above, certain formulations are particularly well suited to aerosol application and can be applied using, e.g., a paint sprayer or can be packaged in a pressurized aerosol spray can.

After one or more painting opeations as the coating(s) formed by the protective composition become marred, they can be refreshed by application of another layer on top of the previous layer.

As desired, the protective composition can readily be removed, e.g., by washing with a water wash.

It is understood that the examples and embodiments described herein are for illustrative purposes only and that various modifications or changes in light thereof will be suggested to persons skilled in the art and are to be included within the spirit and purview of this application and scope of the appended claims. All publications, patents, and patent applications cited herein are hereby incorporated by reference in their entirety for all purposes.

What is claimed is:

1. A coating for the protection of a paint booth, said coating comprising an aqueous mixture of:
a maltodextrin;
a humectant; and
a pH adjuster.

2. The composition of claim 1, wherein said maltodextrin has a DE between about 10, or about 11, or about 12, or about 13, or about 14 up to about 20, or from about, or from about 15 up to about 20 or 19.9, or from about 16 up to about 20 or about 19.9.

3. The composition of claim 2, wherein the maltodextrin has a DE that ranges from about 16.5 to about 19.9.

4. The composition according to any one of claims 1-3, where the maltodextrin ranges from about 1%, or from about 3%, or from about 5%, or from about 8%, or from about 10% up to about 40%, or up to about 35%, or up to about 30%, or up to about 25%, or up to about 21%, or ranges from about 10% to about 21% of the composition or is about 10%, or about 21% of the composition.

5. The composition according to any one of claims 1-4, wherein said composition further comprises a thickener.

6. The composition of claim 5, wherein said thickener comprises an acrylic thickener or an xanthan gum.

7. The composition of claim 5, wherein said thickener comprises a xanthan gum.

8. The composition according to any one of claims 5-7, wherein said thickener comprises about 0.1 to 3 percent, or about 0.2 percent to about 1 percent, or about 0.3 percent up to about 0.5% of the compositions. In certain embodiments the thickener is present at about 0.475% or at about 0.5%, by weight, of the composition.

9. The composition according to any one of claims 1-8, wherein said composition comprises a defoamer.

10. The composition of claim 9, wherein said defoamer comprises a VOC-free defoamer.

11. The composition of claim 10, wherein said defoamer comprises a silicone defoamer.

12. The composition of claim 10, wherein said defoamer comprises a mixture of foam destroying polysiloxanes and hydrophobic solids in polyglycols.

13. The composition according to any one of claims 9-12, wherein said defoamer ranges from about 0.1%, or from about 0.3%, or from about 0.5% up to about 2%, or up to about 1.5%, or up to about 1%, or from about 0.8% up to about 1.2%, or is about 1% by weight of said composition.

14. The composition according to any one of claims 1-12, wherein said composition further comprises a surfactant.

15. The composition of claim 14, wherein said surfactant comprises a non-ionic surfactant.

16. The composition of claim 14, wherein said surfactant comprises a siloxane and/or an ethoxylated alcohol.

17. The composition of claim 14, wherein said surfactant comprises an ethoxylated alcohol.

18. The composition according to any one of claims 14-17. wherein said surfactant ranges from about 0.05%, or from about 0.1% up to about 0.5% of the composition, or up to about 0.4%, or up to about 0.3%, or up to about 0.2% by weight of the composition.

19. The composition according to any one of claims 1-18, wherein said pH adjuster is a water soluble base.

20. The composition of claim 19, wherein said pH adjuster is selected from the group consisting of sodium hydroxide, sodium bicarbonate, pyridine, triethanolamine, and ammonia.

21. The composition according to any one of claims 1-20, wherein said pH adjuster adjusts pH of said composition to between pH 7 and pH 9, or to between about pH 8 to about pH 9.

22. The composition according to any one of claims 1-21, wherein said pH adjuster is also a humectant.

23. The composition of claim 22, wherein pH adjuster comprises triethanolamine.

24. The composition according to any one of claims 1-23, wherein the pH adjuster ranges from about 0.1% up to about 30%, or from about 0.5% up to about 30%, or up to about 20%, or up to about 15%, or up to about 10%, or up to about 1%, or up to about 2%, or up to about 1%, or is about 0.5%, or is about 0.9% of the composition.

25. The composition according to any one of claims 1-24, wherein said humectant is selected from the group consisting of glycerine, sorbitol, sugar, corn syrup, and polypropylene glycol.

26. The composition of claim 25, wherein said humectant comprises glycerine.

27. The composition according to any one of claims 1-26, wherein said humectant ranges from about 2%, 3%, 4%, or 5% of the composition up to about 50%, or up to about 40%, or up to about 30% of the composition, or up to about 20% of the composition, or is about 4 to about 8% or the composition, or is about 12% to about 18% of the composition, or is about 5% of the composition, or is about 15% of the composition.

28. The composition according to any one of claims 1-27, wherein said composition further comprises one or more preservatives.

29. The composition of claim 28, wherein said preservatives comprises one or more agents selected from the group consisting of a combination of as 5-chloro-2-methyl-4-isothiazolin-3-one and 2-methyl-4-isothiazolin-4-one (KATHON LX®), an aqueous dipropylene glycol solution of 1,2-benzisothiazolin-3-one (PROXEL GXL®), benzoic acid, sodium benzoate, hydroxybenzoate and derivatives, lactic acid, nitrate, nitrite, propionic acid, sodium propionate, sulfur, sulfites, sorbic acid sodium sorbate, thimerosol, and potassium metabisulfite.

30. The composition of claim 28, wherein said preservatives comprises one or more agents selected from the group consisting of a combination of as 5-chloro-2-methyl-4-isothiazolin-3-one and 2-methyl-4-isothiazolin-4-one (KATHON LX®), an aqueous dipropylene glycol solution of 1,2-benzisothiazolin-3-one (PROXEL GXL®), and potassium metabisulfite.

31. The composition according to any one of claims 28-30, where each preservative, when present ranges up to about 4%, or up to about 3%, or up to about 2%, or up to about 1% of the composition, or 0.005% up to about to about 1%, or about 0.10% up to about 0.2%, or up to about 0.01%, or up to about 1%, or is about 0.010%, or about 0.95%, or about 0.2% of said composition.

32. The composition according to any one of claims 28-31, wherein said composition comprises up to about 0.10 Kathon LX, or about 0.01% Kathon LX.

33. The composition according to any one of claims 28-32, wherein said composition comprises up to about 4% Proxel GXL, or about 0.2% Proxel GXL.

34. The composition according to any one of claims 28-33, wherein said composition comprises up to about 1% potassium metabisulfite or about 0.95% potassium metabisulfite, or about 0.5% potassium metabisulfite.

35. The composition according to any one of claims 1-34, wherein said composition further comprises a pigment.

36. The composition of claim 35, wherein said pigment is a white pigment.

37. The composition of claim 36, wherein said pigment comprises titanium dioxide.

38. The composition according to any one of claims 35-37, wherein said pigment ranges up to about 12% of said composition or up to about 10% of said composition, or up to about 8% of said composition, or up to about 6% of said composition, or up to about 5% of said composition, or up to about 4% of said composition, or up to about 3% of said composition, or up to about 2% of said composition, or up to about 1% of said composition or comprises about 6% of the composition.

39. The composition of claim 1, wherein said composition comprises:
up to about 25% maltodextrin;
up to about 5% thickener;
up to about 2% defoamer;
up to about 0.5% surfactant;
up to about 30% glycerine;
up to about 30% triethanolamine;
and one or more preservatives.

40. The composition of claim 39, wherein said composition comprises:
about 21% maltodextrin;
about 5% or about 0.475% xanthan gum thickener (e.g. kelzan® ar);
about 0.1% silicone defoamer (e.g., byk-024);
about 0.2% alcohol ethoxylated surfactant (e.g. tomadol 91.6);
about 15% glycerine;
about 0.9% triethanolamine; and
one or more preservatives.

41. The composition of claim 40, wherein said composition further comprises about 6% titanium dioxide.

42. The composition of claim 39, wherein said composition comprises:
about 10% maltodextrin;
about 5% or about 0.475% xanthan gum thickener (e.g. kelzan® ar);
about 0.1% silicone defoamer (e.g., byk-024);
about 0.2% alcohol ethoxylated surfactant (e.g. tomadol 91.6);
about 5% glycerine;
about 0.5% triethanolamine and
one or more preservatives.

43. The composition according to any one of claims 39-42, wherein said composition further comprises about 0.2% Proxel GXL.

44. The composition according to any one of claims 39-43, wherein said composition further comprises about 0.2% Proxel GXL.

45. The composition according to any one of claims 39-44, wherein said composition further comprises about 0.01% Kathon LX.

46. The composition according to any one of claims 39-45, wherein said composition further comprises about 9.14 potassium metabisulfite.

47. The composition according to any one of claims 39-46, wherein the remainder of said composition is distilled or deionized water.

48. The composition according to any one of claims 1-47, wherein said composition remains damp and/or tacky/sticky to the touch after drying.

49. The composition according to any one of claims 1-48, wherein said composition is formulated for aerosol application.

50. The composition of claim 49, wherein said composition is in a paint sprayer.

51. The composition of claim 49, wherein said composition is in a pressurized aerosol spray can.

52. A method of protecting a surface of a paint booth, said method comprising applying the composition according to any one of claims 1-51 to a surface of a paint booth in an amount to form a substantially continuous coating.

53. The method of claim 52, wherein said coating is applied in an amount sufficient to prevent penetration of paint to the underlying surface.

54. The method according to any one of claims 52-53, wherein said applying is by brush, roller, or spraying.

55. The method according to any one of claims 52-54, wherein said method comprises refreshing said paint booth surface by applying said composition again to a previous layer of composition that has been marred by a painting operation (e.g., marred by paint, paint fragments, dust, and the like).

56. The method according to any one of claims 52-55, wherein said method comprises removing said composition from the surface of said paint booth after one or more painting operations.

57. The method of claim 56, wherein said removing is by a water wash.
